(19) United States
(12) Patent Application Publication
(10) Pub. No.: US 2014/0117181 A1
(43) Pub. Date: May 1, 2014

(54) FIXING MECHANISM AND ANTENNA DEVICE THEREWITH

(71) Applicant: Wistron NeWeb Corporation, Hsinchu (TW)

(72) Inventors: Lan-Chun Yang, Hsinchu (TW); Ming-Chan Lee, Hsinchu (TW); Yi-Chieh Lin, Hsinchu (TW); Hung-Yuan Lin, Hsinchu (TW)

(73) Assignee: WISTRON NEWEB CORPORATION, Hsinchu (TW)

(21) Appl. No.: 13/798,110

(22) Filed: Mar. 13, 2013

Related U.S. Application Data
(60) Provisional application No. 61/721,481, filed on Nov. 1, 2012.

(30) Foreign Application Priority Data
Dec. 12, 2012 (TW) 101146987

(51) Int. Cl. H01Q 1/12

(52) U.S. Cl. CPC H01Q 1/12
USPC 248/231.9; 403/322.4

(57) ABSTRACT

A fixing mechanism with easy assembly and for fixing an antenna holder and a supporting tube is disclosed. The fixing mechanism includes a shaft, a constraining member, a pivot member and a handle. The shaft is for disposing through a first fixing structure of the antenna holder and a second fixing structure of the supporting tube. The constraining member is connected to an end portion of the shaft, and the pivot member is connected to another end portion of the shaft. The pivot member and the constraining member are cooperatively for constraining the shaft from separating from the first fixing structure and the second fixing structure. The handle is pivoted to the pivot member, and the handle drives the pivot member to activate the shaft to pull the constraining member, so as to press the antenna holder and the supporting tube cooperatively with the constraining member.

### CROSS REFERENCE TO RELATED APPLICATIONS

This application is a non-provisional application of a U.S. provisional application Ser. No. 61/721,481, filed Nov. 1, 2012.

### BACKGROUND OF THE INVENTION

1. Field of the Invention

The present invention relates to a fixing mechanism and an antenna device therewith, and more particularly, to a fixing mechanism with easy assembly and for fixing an antenna holder and a supporting tube of an antenna device and an antenna device therewith.

2. Description of the Prior Art

A conventional antenna device includes an antenna holder, a supporting tube and a fixing mechanism. The supporting tube is used for supporting the antenna holder, and the antenna holder is used for holding an antenna component, so that the antenna component is capable of receiving antenna signals. The fixing mechanism is used for fixing the antenna holder and the supporting tube, so that the supporting tube supports the antenna holder stably. Conventionally, the fixing mechanism fixes the antenna holder and the supporting tube in a screwed and manually manner, so that the antenna holder firmly fixes the supporting tube. The aforesaid design requires additional tools, such as a screw driver, for screwing, resulting in complex process of assembly, and thus it is not convenient for a user to install and use.

### SUMMARY OF THE INVENTION

The present invention provides a fixing mechanism with easy assembly and an antenna device therewith for solving above drawbacks.

According to an embodiment of the present invention, a fixing mechanism for fixing an antenna holder and a supporting tube is disclosed. The supporting tube is detachably installed on the antenna holder, and the antenna holder includes a first fixing structure. The supporting tube includes a second fixing structure, and the fixing mechanism includes a shaft, a constraining member, a pivot member and a handle. The shaft is for disposing through the first fixing structure of the antenna holder and the second fixing structure of the supporting tube when the antenna holder is installed on the supporting tube. The constraining member is connected to an end portion of the shaft. The pivot member is connected to another end portion of the shaft, and the pivot member and the constraining member are cooperatively for constraining the shaft from separating from the first fixing structure and the second fixing structure. The handle is pivoted to the pivot member, and the handle drives the pivot member to activate the shaft to pull the constraining member when the handle is rotated relative to the pivot member, so as to press the antenna holder and the supporting tube cooperatively with the constraining member.

According to another embodiment of the present invention, a first inner thread structure is formed on the constraining member, and the shaft includes a first outer thread structure formed on the end portion of the shaft. The first outer thread structure is screwed with the first inner thread structure, so that the constraining member is detachably connected to the end portion of the shaft.

According to another embodiment of the present invention, a plurality of first empty slots is further formed on the constraining member, and a plurality of second empty slots is further formed on the end portion of the shaft. The first inner thread structure and the first outer thread structure respectively cooperate with the plurality of second empty slots and the plurality of first empty slots, so that the end portion of the shaft slides along the constraining member.

According to another embodiment of the present invention, the constraining member is welded on the supporting tube and located in a position corresponding to the second fixing structure.

According to another embodiment of the present invention, a second inner thread structure is formed on the pivot member, and the shaft further includes a second outer thread structure formed on the other end portion of the shaft. The second outer thread structure is screwed with the second inner thread structure, so that the pivot member is detachably connected to the other end portion of the shaft.

According to another embodiment of the present invention, the constraining member and the shaft are integrally formed, and the constraining member includes a connecting portion and at least one wing portion. The connecting portion is combined with the end portion of the shaft. The at least one wing portion protrudes from the connecting portion and is oriented perpendicular to the shaft. The at least one wing portion passes through the first fixing structure of the antenna holder and the second fixing structure of the supporting tube in a first orientation. The at least one wing portion is rotated with the shaft for wedging the first fixing structure of the antenna holder and the second fixing structure of the supporting tube after the at least one wing portion passes through the first fixing structure of the antenna holder and the second fixing structure of the supporting tube.

According to another embodiment of the present invention, the first orientation is perpendicular to the second orientation.

According to another embodiment of the present invention, the handle includes a pivotal portion, a pressing cam and a handle portion. The pivotal portion is pivoted to the pivot member. The pressing cam protrudes from the pivotal portion. The handle portion is connected to the pivotal portion, and the handle portion is for rotating the pivotal portion to drive the pressing cam to press the antenna holder and the supporting tube.

According to another embodiment of the present invention, an antenna device includes an antenna holder, a supporting tube and a fixing mechanism. The antenna holder includes a first fixing structure. The supporting tube is detachably installed on the antenna device and includes a second fixing structure. The fixing mechanism is for fixing the antenna holder and the supporting tube and includes a shaft, a constraining member, a pivot member and a handle. The shaft is for disposing through the first fixing structure of the antenna holder and the second fixing structure of the supporting tube when the antenna holder is installed on the supporting tube. The constraining member is connected to an end portion of the shaft. The pivot member is connected to another end portion of the shaft, and the pivot member and the constraining member are cooperatively for constraining the shaft from separating from the first fixing structure and the second fixing structure. The handle is pivoted to the pivot member, and the handle drives the pivot member to activate the shaft to pull the constraining member when the handle is rotated relative to the pivot member, so as to press the antenna holder and the supporting tube cooperatively with the constraining member.

According to another embodiment of the present invention, the first fixing structure and the second fixing structure are respectively a through hole structure.

According to another embodiment of the present invention, the first fixing structure and the second fixing structure are respectively a long-shaped through hole structure.

In summary, the present invention utilizes the handle to drive the pivot member to activate the shaft to pull the constraining member, so that the handle and the constraining member cooperatively press the antenna holder and the supporting tube. Accordingly, the present invention is capable of firmly fixing the antenna holder and the supporting tube, and it only needs rotation of the handle to drive the pivot member to activate the shaft to pull the constraining member. As a result, it does not require an additional tool for assisting installation, resulting in easy assembly for being capable of saving labors and hours during production and facilitating the user to install and use.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of an antenna device according to a first embodiment of the present invention.

FIG. 2 is an exploded diagram of the antenna device and a fixing mechanism according to the first embodiment of the present invention.

FIG. 3 is an assembly diagram illustrating the fixing mechanism is used for fixing an antenna holder and a supporting tube according to the first embodiment of the present invention.

FIG. 4 is an exploded diagram of a shaft and a constraining member according to a second embodiment of the present invention.

FIG. 5 is a diagram illustrating a first end portion of the shaft is installed on the constraining member according to the second embodiment of the present invention.

FIG. 6 and FIG. 7 are exploded diagrams of an antenna holder, a supporting tube and a fixing mechanism in different statuses according to a third embodiment of the present invention.

FIG. 8 and FIG. 9 are diagrams of an antenna device in different fixed statuses according to the third embodiment of the present invention.

FIG. 10 is a diagram of the antenna holder, the supporting tube and the fixing mechanism in a different status according to the third embodiment of the present invention.

FIG. 11 is a schematic diagram of an antenna device according to a fourth embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. In this regard, directional terminology, such as “top,” “bottom,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

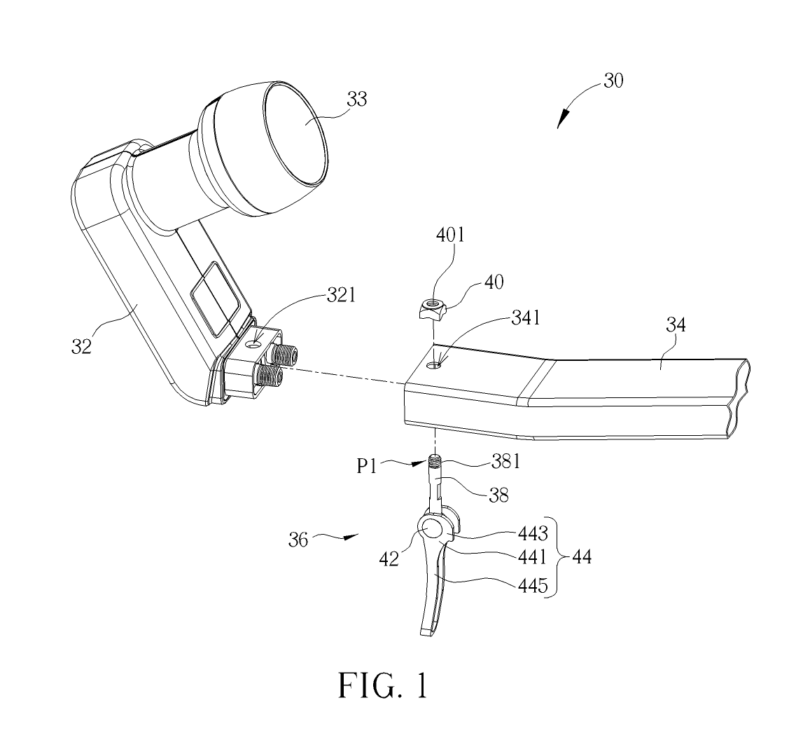

Please refer to FIG. 1. FIG. 1 is an exploded diagram of an antenna device 30 according to a first embodiment of the present invention. As shown in FIG. 1, the antenna device 30 includes an antenna holder 32 and a supporting tube 34. The supporting tube 34 is detachably installed on the antenna holder 32. In this embodiment, the supporting tube 34 is an antenna supporting tube, and the antenna holder 32 is used for holding an antenna component 33. In addition, the antenna device 30 further includes a fixing mechanism 36 for fixing the antenna holder 32 and the supporting tube 34, so that the antenna component 33 is fixed on the supporting tube 34 by utilizing the antenna holder 32. In such a manner, the antenna component 33 can be set on a fixing plane, such as a ground by utilizing the antenna holder 32 and the supporting tube 34 for receiving antenna signals.

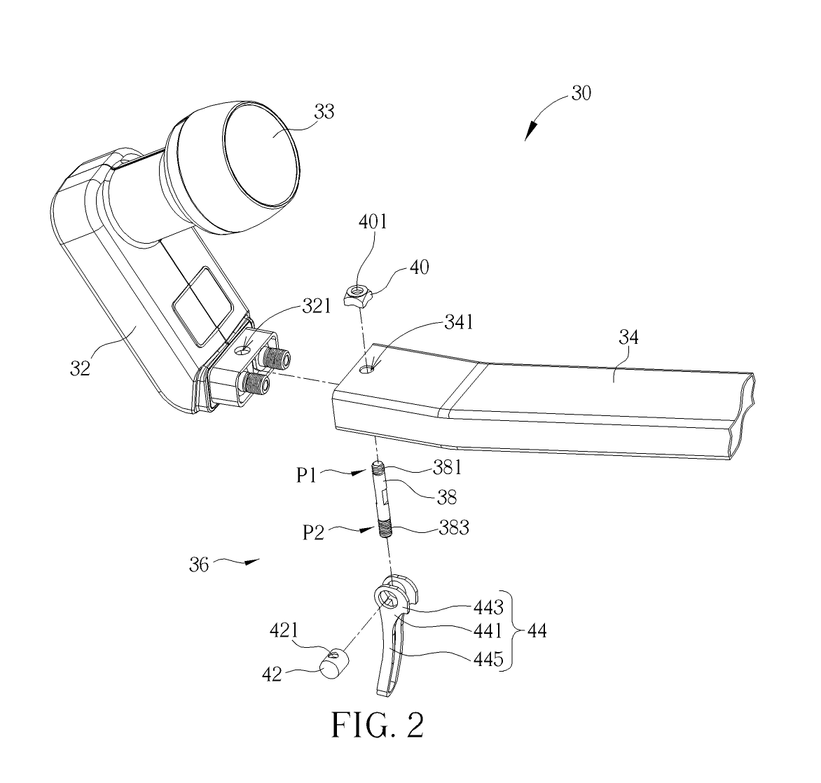

Please refer to FIG. 1 and FIG. 2. FIG. 2 is an exploded diagram of the antenna device 30 and the fixing mechanism 36 according to the first embodiment of the present invention. As shown in FIG. 1 and FIG. 2, the antenna holder 32 includes a first fixing structure 321, the supporting tube 34 includes a second fixing structure 341, and the fixing mechanism 36 includes a shaft 38. In this embodiment, the first fixing structure 321 and the second fixing structure 341 are respectively a through hole structure. Furthermore, when the supporting tube 34 and the antenna holder 32 are installed, the supporting tube 34 is inserted into the antenna holder 32 until the second fixing structure 341 (i.e. the through hole structure) of the supporting tube 34 is aligned with the first fixing structure 321 (i.e. the through hole structure) of the antenna holder 32. Meanwhile, the shaft 38 can dispose through the first fixing structure 321 of the antenna holder 32 and the second fixing structure 341 of the supporting tube 34, so as to constrain the antenna holder 32 from separating from the supporting tube 34.

In addition, the fixing mechanism 36 further includes a constraining member 40 whereon a first inner thread structure 401 is formed, and the shaft 38 includes a first outer thread structure 381 formed on a first end portion P1 of the shaft 38. The first outer thread structure 381 of the shaft 38 is used for being screwed with the first inner thread structure 401 on the constraining member 40, so that the constraining member 40 is detachably connected to the first end portion P1 of the shaft 38 . In addition, the fixing mechanism 36 further includes a pivot member 42 whereon a second inner thread structure 421 is formed, and the shaft 38 further includes a second outer thread structure 383 formed on a second end portion P2 corresponding to the first end portion P1 of the shaft 38. The second outer thread structure 383 of the shaft 38 is used for being screwed with the second inner thread structure 421 on the pivot member 42, so that the pivot member 42 is detachably connected to the second end portion P2 of the shaft 38. Furthermore, the fixing mechanism 36 further includes a handle 44 pivoted to the pivot member 42. The handle 44 includes a pivotal portion 441, a pressing cam 443 and a handle portion 445. The pivotal portion 441 is pivoted to the pivot member 42, the pressing cam 443 protrudes from the pivotal portion 441, and the handle portion 445 is connected to the pivotal portion 441.

When the fixing mechanism 36 is utilized for fixing the antenna holder 32 and the supporting tube 34, the pivot member 42 is installed inside the pivotal portion 441 of the handle 44 first, so as to pivot the pivotal portion 441 of the handle 44 to the pivot member 42. Afterwards, the second outer thread structure 383 on the second end portion P2 of the shaft 38 is screwed with the second inner thread structure 421 on the pivot member 42, so as to connect the pivot member 42 to the second end portion P2 of the shaft 38. In such a manner, the pivot member 42, the handle 44 and the shaft 38 of the fixing mechanism 36 can be integrated as an independent assembly for facilitating the following assembly process. Practically, the pivot member 42, the handle 44 and the shaft 38 of the fixing mechanism 36 can be assembled as the aforesaid independent assembly in advance, so as to reduce an amount of part on the production line during mass production. Accordingly, it can enhance convenience during the fixing mechanism 36 is assembled.

After the pivot member 42, the handle 44 and the shaft 38 are assembled as the independent assembly, the first end portion P1 of the shaft 38 of the aforesaid independent assembly is disposed through the first fixing structure 321 of the antenna holder 32 and the second fixing structure 341 of the supporting tube 34 until the first end portion P1 of the shaft 38 protrudes from the antenna holder 32 and the supporting tube 34. Meanwhile, the first outer thread structure 381 on the first end portion P1 of the shaft 38 is exposed from the antenna holder 32 and the supporting tube 34. Afterwards, the first inner thread structure 401 on the constraining member 40 is screwed with the first outer thread structure 381 on the first end portion P1 of the shaft 38, so that the constraining member 40 is connected to the first end portion P1 of the shaft 38, so as to constrain the first end portion P1 of the shaft 38 from separating from the antenna holder 32 and the supporting tube 34.

As mentioned above, the first end portion P1 of the shaft 38 can be constrained on the antenna holder 32 and the supporting tube 34 by the constraining member 40, and the second end portion P2 of the shaft 38 can be constrained on the antenna holder 32 and the supporting tube 34 by the pivot member 42 and the handle 44. In other words, the pivot member 42 and the constraining member 40 can cooperatively constrain the shaft 38 from separating from the first fixing structure 321 of the antenna holder 32 and the second fixing structure 341 of the supporting tube 34, so that the shaft 38 constrained inside the first fixing structure 321 and the second fixing structure 341 is used for constraining the antenna holder 32 from separating from the supporting tube 34.

In this embodiment, the constraining member 40 and the supporting tube 34 are two separate members, i.e. the constraining member 40 and the supporting tube 34 can separate from each other. Structures of the constraining member 40 and the supporting tube 34 are not limited to those mentioned in this embodiment. For example, the constraining member 40 can be welded on the supporting tube 34 and located in a position corresponding to the second fixing structure 341 as well. In other words, the first inner thread structure 401 on the constraining member 40 can be aligned with the second fixing structure 341 on the supporting tube 34 first, and then the constraining member 40 can be welded on the supporting tube 34. In such a manner, the constraining member 40 can be fixed on the supporting tube 34 in advance without manually disposing the constraining member 40 during the shaft 38 is screwed with the constraining member 40 for saving labors and costs. As for which one of the above-mentioned designs is adopted, it depends on practical demands.

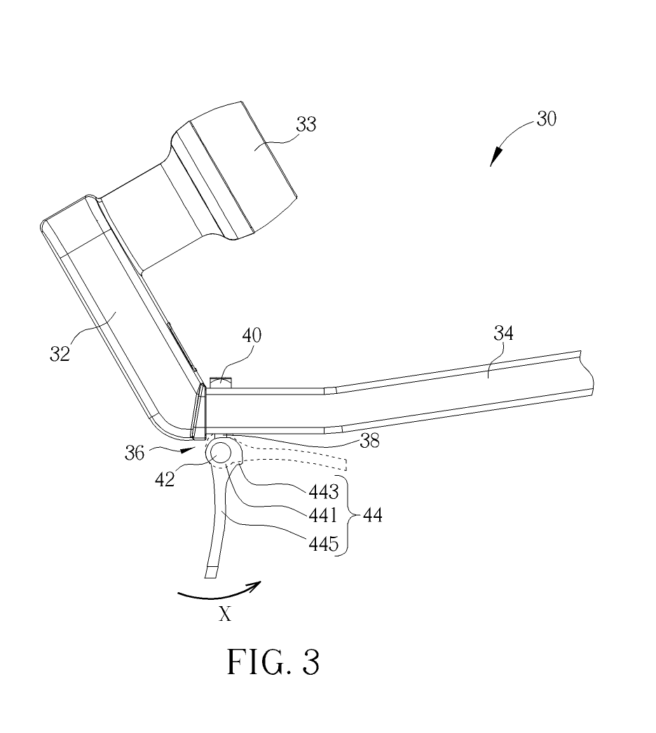

Please refer to FIG. 3. FIG. 3 is an assembly diagram illustrating the fixing mechanism 36 is used for fixing the antenna holder 32 and the supporting tube 34 according to the first embodiment of the present invention. As shown in FIG. 3, after the fixing mechanism 36, the antenna holder 32 and the supporting tube 34 are fixed, the antenna holder 32 and the supporting tube 34 can be constrained in a status shown in FIG. 3 by the shaft 38 of the fixing mechanism 36. Afterwards, the handle portion 445 of the handle 44 is rotated in a pressing direction X shown in FIG. 3, so that the handle 44 is rotated relative to the pivot member 42 in the pressing direction X.

During the handle 44 is rotated relative to the pivot member 42 in the pressing direction X, the pressing cam 443 of the handle 44 abuts against the bottom surface of the supporting tube 34. Afterwards, when the handle 44 continues to be rotated in the pressing direction X, the pressing cam 443 is capable of sliding on the bottom surface of the supporting tube 34, so that the pivotal portion 441 of the handle 44 displaces downwards from the bottom surface of the supporting tube 34. Meanwhile, the pivotal portion 441 drives the pivot member 42 to displace downwards from the bottom surface of the supporting tube 34. Accordingly, the pivot member 42 can activate the shaft 38 to pull the constraining member 40.

Furthermore, when the handle 44 is rotated relative to the pivot member 42 in the pressing direction X shown in FIG. 3 from the status illustrated in solid line to the status illustrated in dashed line, the pressing cam 443 of the handle 44 and the constraining member 40 can cooperatively press the antenna holder 32 and the supporting tube 34. In such a manner, the supporting tube 34 can be pressed by the constraining member 40 of the fixing mechanism 36 and the pressing cam 443 of the handle 44 for being firmly fixed on the antenna holder 32.

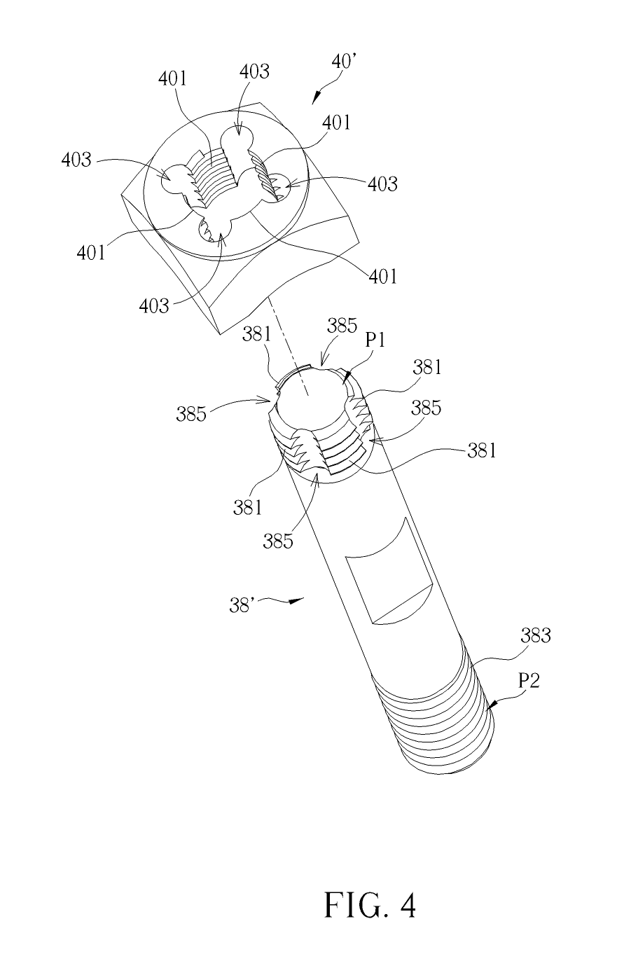

Please refer to FIG. 4. FIG. 4 is an exploded diagram of a shaft 38′ and a constraining member 40′ according to a second embodiment of the present invention. As shown in FIG. 4, the main difference between the constraining member 40′ and the aforesaid constraining member 40 is that a plurality of empty slots 403 is further formed on the constraining member 40′, and the plurality of first empty slots 403 is spaced at intervals and adjacent to the first inner thread structure 401. In this embodiment, the first empty slots 403 are used for dividing the first inner thread structure 401 on the constraining member 40′ into equal parts. In addition, the main difference between the shaft 38′ and the aforesaid shaft 38 is that a plurality of second empty slots 385 is further formed on the shaft 38′, and the plurality of second empty slots 385 is spaced at intervals and adjacent to the first outer thread structure 381. In this embodiment, the second empty slots 385 are used for dividing the first outer thread structure 381 on the shaft 38′ into equal parts.

In this embodiment, there are four first empty slots 403 formed on the constraining member 40′, i.e. the first empty slots 403 divide the first inner thread structure 401 on the constraining member 40′ into four equally parts. In addition, there are four second empty slots 385 which correspond to the first empty slots 403 on the constraining member 40′ and are formed on the shaft 38′, i.e. the second empty slots 385 divide the first outer thread structure 381 on the shaft 38′ into four equally parts. Amounts and disposal positions of the first empty slots 403 and the second empty slots 385 are not limited to those illustrated in figures in this embodiment, and it depends on practical demands.

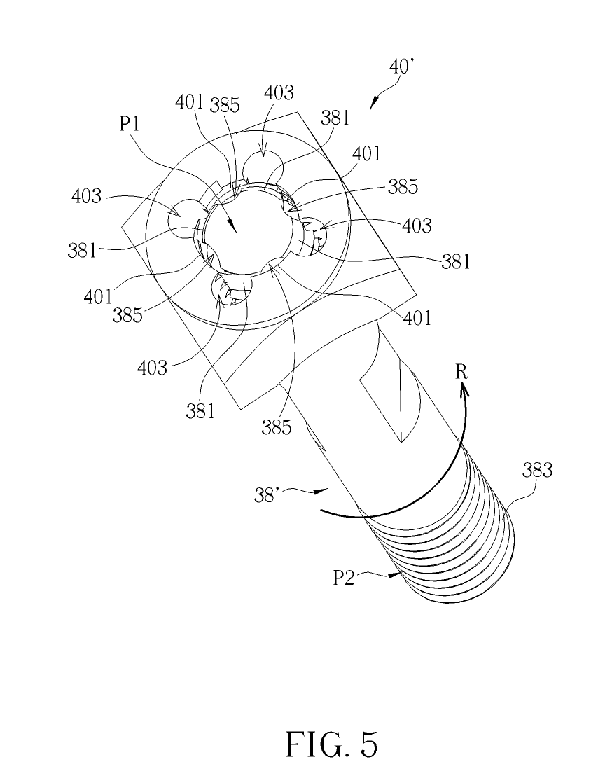

Please refer to FIG. 4 and FIG. 5. FIG. 5 is a diagram illustrating the first end portion P1 of the shaft 38′ is installed on the constraining member 40′ according to the second embodiment of the present invention. As shown in FIG. 4 and FIG. 5, when the first outer thread structure 381 on the shaft 38′ is screwed with the first inner thread structure 401 on the constraining member 40′, the first outer thread structure 381 on the shaft 38′ is aligned with the first empty slots 403 on the constraining member 40′ first. Meanwhile, the second empty slots 385 on the shaft 38′ is simultaneously aligned with the first inner thread structure 401 on the constraining member 40′.

In such a manner, during the first end portion P1 of the shaft 38′ is inserted into the constraining member 40′, the first outer thread structure 381 on the shaft 38′ is capable of sliding inside the first empty slots 403 on the constraining member 40′, and the first inner thread structure 401 on the constraining member 40′ is capable of sliding inside the second empty slots 385 on the shaft 38′ simultaneously. In other words, the first outer thread structure 381 on the shaft 38′ and the first inner thread structure 401 on the constraining member 40′ are respectively used for cooperating with the first empty slots 403 on the constraining member 40′ and the second empty slots 385 on the shaft 38′, so that the first end portion P1 of the shaft 38′ is capable of sliding along the constraining member 40′ from a position shown in FIG. 4 to a position shown in FIG. 5.

Furthermore, when the first end portion P1 of the shaft 38′ slides to the position shown in FIG. 5, the shaft 38′ is rotated in a rotating direction R shown in FIG. 5. Meanwhile, the first outer thread structure 381 on the shaft 38′ separates from the first empty slots 403 on the constraining member 40′ and further engages with the first inner thread structure 401 on the constraining member 40′. In such a manner, the first end portion P1 of the shaft 38′ can be screwed with the constraining member 40′, so as to prevent the first end portion P1 of the shaft 38′ from separating from the constraining member 40′. As a result, the first end portion P1 of the shaft 38′ is constrained on the antenna holder 32 and the supporting tube 34.

In summary, the first empty slots 403 on the constraining member 40′ and the second empty slots 385 on the shaft 38′ allow that the first end portion P1 of the shaft 38′ is inserted into the constraining member 40′ in a slidable manner. When the first end portion P1 of the shaft 38′ reaches a specific distance within the constraining member 40′, the shaft 38′ is rotated to screw the first end portion P1 of the shaft 38′ with the constraining member 40′. Accordingly, the first empty slots 403 and the second empty slots 385 allow the first end portion P1 of the shaft 38′ to rapidly achieve the screwing position for screwing with the constraining member 40′, so as to save labor time when assembling the first end portion P1 of the shaft 38′ and the constraining member 40′.

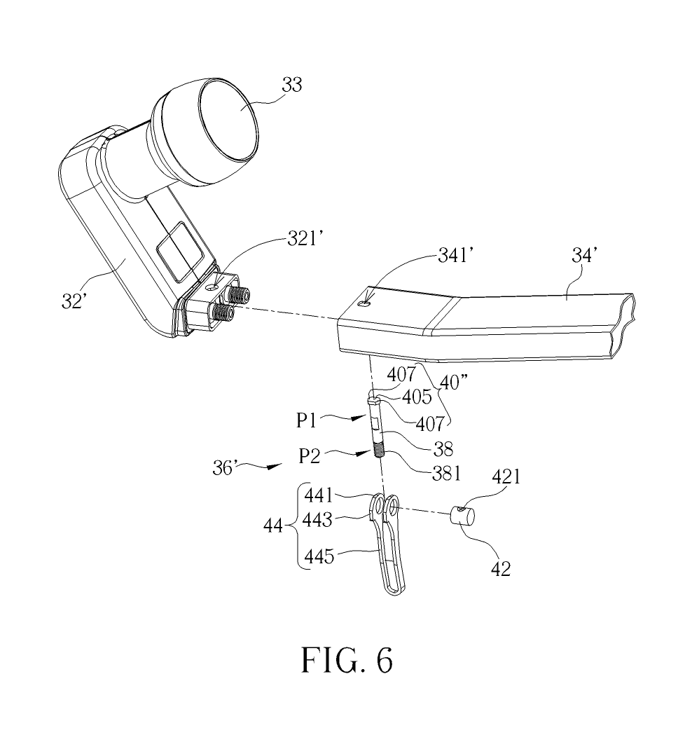

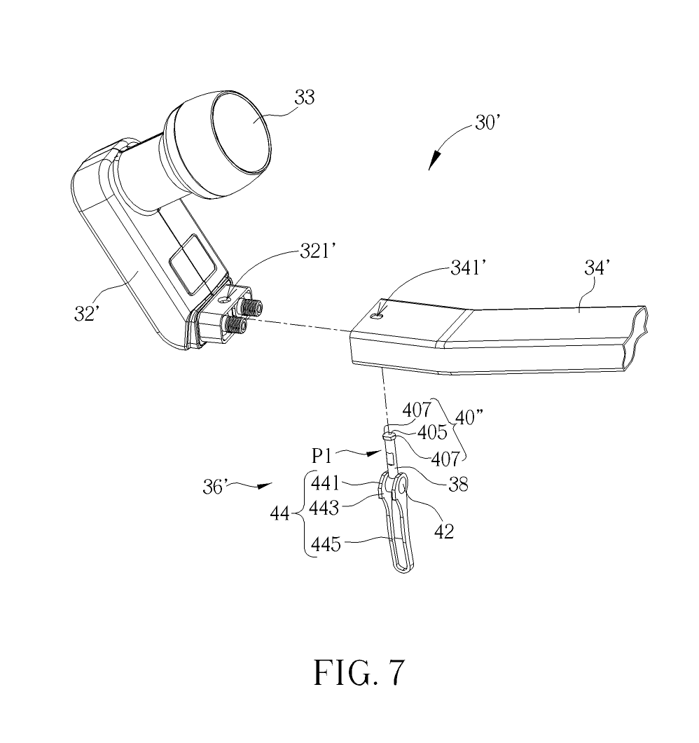

Please refer to FIG. 6 and FIG. 7. FIG. 6 and FIG. 7 are exploded diagrams of an antenna holder 32′, a supporting tube 34′ and a fixing mechanism 36′ in different statuses according to a third embodiment of the present invention. As shown in FIG. 6 and FIG. 7, the main difference between the fixing mechanism 36′ and the aforesaid fixing mechanism 36 is that a shaft 38″ and a constraining member 40″ of the fixing mechanism 36′ are integrally formed, and the constraining member 40′ of the fixing mechanism 36′ includes a connecting portion 405 and at least one wing portion 407. The connecting portion 405 is combined with the first end portion P1 of the shaft 38″, and the at least one wing portion 407 protrudes from the connecting portion 405 and is oriented perpendicular to the shaft 38″.

In this embodiment, the first fixing structure 321′ of the antenna holder 32′ and the second fixing structure 341′ of the supporting tube 34′ are respectively a long-shaped through hole structure, and profiles of the long-shaped through hole structures (i.e. the first fixing structure 321′ and the second fixing structure 341′) are substantially identical to a profile of the at least one wing portion 407 of the constraining member 40′, so that the at least one wing portion 407 of the constraining member 40″ can pass the long-shaped through hole structures. In this embodiment, the constraining member 40″ includes two wing portions 407 protruding from two sides of the connecting portion 405 and oriented perpendicular to the shaft 38″, respectively. In other words, the constraining member 40″ is a substantially T-shaped structure. An amount and disposal positions of the wing portion 407 are not limited to those illustrated in figures in this embodiment. For example, the constraining member 40″ can include only one wing portion 407 protruding from one side of the connecting portion 405 and oriented perpendicular to the shaft 38″ as well. In other words, the constraining member 40″ can be an L-shaped structure as well. As for which one of the above-mentioned designs is adopted, it depends on practical demands.

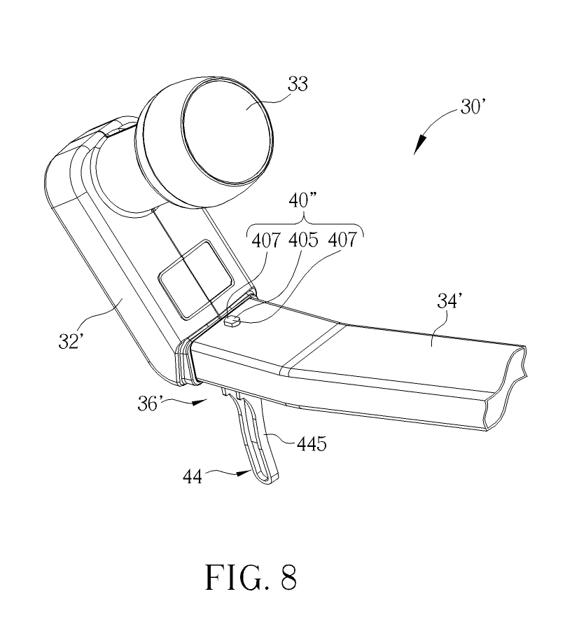

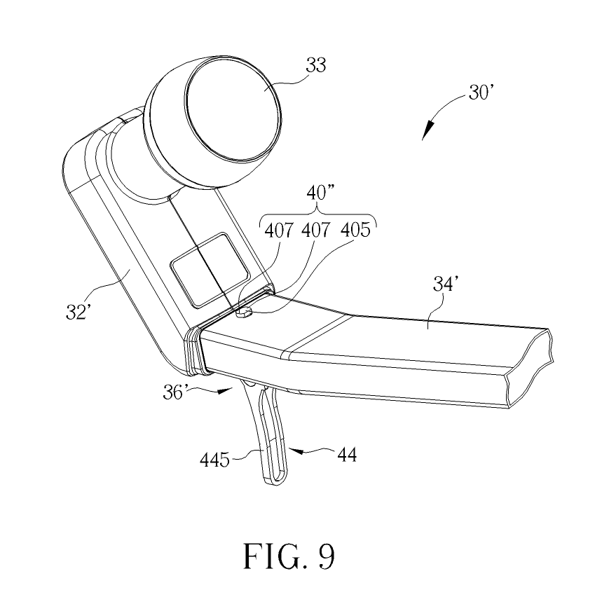

Please refer to FIG. 7 to FIG. 9. FIG. 8 and FIG. 9 are diagrams of an antenna device 30′ in different fixed statuses according to the third embodiment of the present invention. As shown in FIG. 7 to FIG. 9, when the fixing mechanism 36′ is utilized for fixing the antenna holder 32′ and the supporting tube 34′, the wing portions 407 of the constraining member 40″ of the fixing mechanism 36′ is disposed through the first fixing structure 321′ of the antenna holder 32′ and the second fixing structure 341′ of the supporting tube 34′ in a first orientation first, as shown in FIG. 7. When the wing portions 407 of the constraining member 40′ of the fixing mechanism 36′ reaches a position shown in FIG. 8, the shaft 38″ of the fixing mechanism 36′ can be embedded into the first fixing structure 321′ and the second fixing structure 341′, so as to constrain the antenna holder 32′ from separating from the supporting tube 34′.

Afterwards, the shaft 38″ of the fixing mechanism 36′ is rotated from the position shown in FIG. 8. Meanwhile, the wing portions 407 of the constraining member 40′ are rotated with the shaft 38′ to achieve the position shown in FIG. 9. At the same time, the wing portions 407 of the constraining member 40′ are wedged with the first fixing structure 321′ of the antenna holder 32′ and the second fixing structure 341′ of the supporting tube 34′ in a second orientation, so as to constrain the wing portions 407 of the constraining member 40″ on the antenna holder 32′ and the supporting tube 34′. In this embodiment, the first orientation, as shown in FIG. 8, is substantially perpendicular to the second orientation, as shown in FIG. 9.

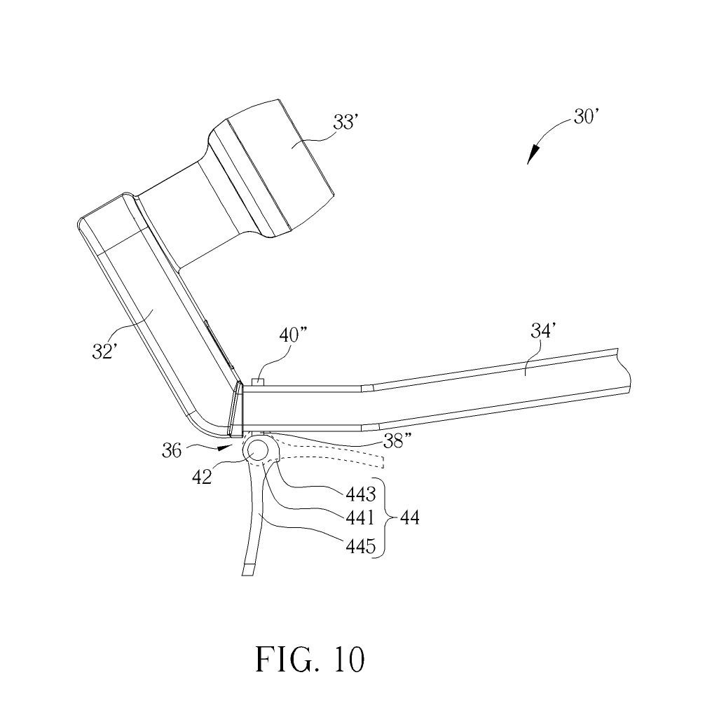

Please refer to FIG. 10. FIG. 10 is a diagram of the antenna holder 32′, the supporting tube 34′ and the fixing mechanism 36′ in a different status according to the third embodiment of the present invention. As shown in FIG. 10, after the wing portions 407 of the constraining member 40″ are constrained on the antenna holder 32′ and the supporting tube 34′, the handle 44 of the fixing mechanism 36′ can be rotated from a position illustrated in solid lines to a position illustrated in dashed lines, as shown in FIG. 10. Meanwhile, the handle 44 of the fixing mechanism 36′ and the wing portions 407 of the constraining member 40′ can be press the supporting tube 34′ onto the antenna holder 32′. Components with denotations in this embodiment identical to those in the aforesaid embodiment have identical structures and functions, and further description is omitted herein for simplicity.

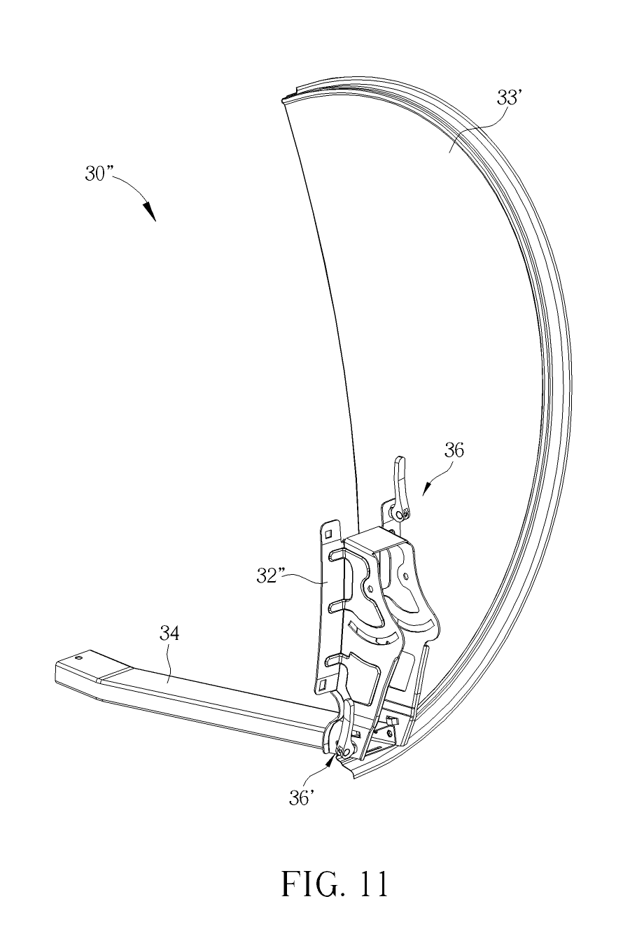

It should be noticed that implementations of the fixing mechanism 36 and the fixing mechanism 36′ are not limited to those mentioned in the aforesaid embodiments. Please refer to FIG. 11. FIG. 11 is a schematic diagram of an antenna device 30″ according to a fourth embodiment of the present invention. As shown in FIG. 11, the main difference between the antenna device 30″ and the aforesaid antenna device 30 is that an antenna component 33′ of the antenna device 30″ is disk-shaped, i.e. the antenna component 33′ of the antenna device 30″ is a disk-shaped antenna. Furthermore, an antenna holder 32′ of the antenna device 30′ is used for holding the antenna component 33′. In this embodiment, the fixing mechanism 36′ is, but not limited to, used for fixing the antenna holder 32″ and the supporting tube 34, i.e. the antenna component 33′ and the antenna holder 32″ of the antenna device 30″ can fix each other by selectively utilizing the fixing mechanism 36 or the fixing mechanism 36′, and the antenna holder 32″ and the supporting tube 34 of the antenna device 30′ can fix each other by selectively utilizing the fixing mechanism 36 or the fixing mechanism 36′. As for which one of the above-mentioned designs is adopted, it depends on practical demands.

Compared to the prior art, the present invention utilizes the handle to drive the pivot member to activate the shaft to pull the constraining member, so that the handle and the constraining member cooperatively press the antenna holder and the supporting tube. Accordingly, the present invention is capable of firmly fixing the antenna holder and the supporting tube, and it only needs rotation of the handle to drive the pivot member to activate the shaft to pull the constraining member. As a result, it does not require an additional tool for assisting installation, resulting in easy assembly for being capable of saving labors and hours during production and facilitating the user to install and use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fixing mechanism with easy assembly and for fixing an antenna holder and a supporting tube, the supporting tube being detachably installed on the antenna holder, the antenna holder comprising a first fixing structure, the supporting tube comprising a second fixing structure, the fixing mechanism comprising:
a shaft for disposing through the first fixing structure of the antenna holder and the second fixing structure of the supporting tube when the antenna holder is installed on the supporting tube;
a constraining member connected to an end portion of the shaft;
a pivot member connected to another end portion of the shaft, the pivot member and the constraining member being cooperatively for constraining the shaft from separating from the first fixing structure and the second fixing structure; and
a handle pivoted to the pivot member, the handle driving the pivot member to activate the shaft to pull the constraining member when the handle is rotated relative to the pivot member, so as to press the antenna holder and the supporting tube cooperatively with the constraining member.

2. The fixing mechanism of claim 1, wherein a first inner thread structure is formed on the constraining member, and the shaft comprises:
a first outer thread structure formed on the end portion of the shaft, the first outer thread structure being screwed with the first inner thread structure, so that the constraining member is detachably connected to the end portion of the shaft.

3. The fixing mechanism of claim 2, wherein a plurality of first empty slots is further formed on the constraining member, a plurality of second empty slots is further formed on the end portion of the shaft, the first inner thread structure and the first outer thread structure respectively cooperate with the plurality of second empty slots and the plurality of first empty slots, so that the end portion of the shaft slides along the constraining member.

4. The fixing mechanism of claim 2, wherein the constraining member is welded on the supporting tube and located in a position corresponding to the second fixing structure.

5. The fixing mechanism of claim 2, wherein a second inner thread structure is formed on the pivot member, and the shaft further comprises:
a second outer thread structure formed on the other end portion of the shaft, the second outer thread structure being screwed with the second inner thread structure, so that the pivot member is detachably connected to the other end portion of the shaft.

6. The fixing mechanism of claim 1, wherein the constraining member and the shaft are integrally formed, and the constraining member comprises:
a connecting portion combined with the end portion of the shaft; and
at least one wing portion protruding from the connecting portion and oriented perpendicular to the shaft, the at least one wing portion passing through the first fixing structure of the antenna holder and the second fixing structure of the supporting tube in a first orientation, the at least one wing portion being rotated with the shaft for wedging the first fixing structure of the antenna holder and the second fixing structure of the supporting tube after the at least one wing portion passes through the first fixing structure of the antenna holder and the second fixing structure of the supporting tube.

7. The fixing mechanism of claim 6, wherein the first orientation is perpendicular to the second orientation.

8. The fixing mechanism of claim 1, wherein the handle comprises:
a pivotal portion pivoted to the pivot member;
a pressing cam protruding from the pivotal portion; and
a handle portion connected to the pivotal portion, the handle portion being for rotating the pivotal portion to drive the pressing cam to press the antenna holder and the supporting tube.

9. An antenna device, comprising:
an antenna holder comprising a first fixing structure;
a supporting tube detachably installed on the antenna device and comprising a second fixing structure; and
a fixing mechanism for fixing the antenna holder and the supporting tube, comprising:
a shaft for disposing through the first fixing structure of the antenna holder and the second fixing structure of the supporting tube when the antenna holder is installed on the supporting tube;
a constraining member connected to an end portion of the shaft;
a pivot member connected to another end portion of the shaft, the pivot member and the constraining member being cooperatively for constraining the shaft from separating from the first fixing structure and the second fixing structure; and
a handle pivoted to the pivot member, the handle driving the pivot member to activate the shaft to pull the constraining member when the handle is rotated relative to the pivot member, so as to press the antenna holder and the supporting tube cooperatively with the constraining member.

10. The antenna device of claim 9, wherein a first inner thread structure is formed on the constraining member, and the shaft comprises:
a first outer thread structure formed on the end portion of the shaft, the first outer thread structure being screwed with the first inner thread structure, so that the constraining member is detachably connected to the end portion of the shaft.

11. The antenna device of claim 10, wherein a plurality of first empty slots is further formed on the constraining member, a plurality of second empty slots is further formed on the end portion of the shaft, the first inner thread structure and the first outer thread structure respectively cooperate with the plurality of second empty slots and the plurality of first empty slots, so that the end portion of the shaft slides along the constraining member.

12. The antenna device of claim 10, wherein the constraining member is welded on the supporting tube and located in a position corresponding to the second fixing structure.

13. The antenna device of claim 10, wherein a second inner thread structure is formed on the pivot member, and the shaft further comprises:
a second outer thread structure formed on the other end portion of the shaft, the second outer thread structure being screwed with the second inner thread structure, so that the pivot member is detachably connected to the other end portion of the shaft.

14. The antenna device of claim 10, wherein the first fixing structure and the second fixing structure are respectively a through hole structure.

15. The antenna device of claim 9, wherein the constraining member and the shaft are integrally formed, and the constraining member comprises:
a connecting portion combined with the end portion of the shaft; and
at least one wing portion protruding from the connecting portion and oriented perpendicular to the shaft, the at least one wing portion passing through the first fixing structure of the antenna holder and the second fixing structure of the supporting tube in a first orientation, the at least one wing portion being rotated with the shaft for wedging the first fixing structure of the antenna holder and the second fixing structure of the supporting tube after the at least one wing portion passes through the first fixing structure of the antenna holder and the second fixing structure of the supporting tube.

16. The antenna device of claim 15, wherein the first orientation is perpendicular to the second orientation.

17. The antenna device of claim 15, wherein the first fixing structure and the second fixing structure are respectively a long-shaped through hole structure.

18. The antenna device of claim 9, wherein the handle comprises:
a pivotal portion pivoted to the pivot member;
a pressing cam protruding from the pivotal portion; and
a handle portion connected to the pivotal portion, the handle portion being for rotating the pivotal portion to drive the pressing cam to press the antenna holder and the supporting tube.
